(19) United States
(12) Patent Application Publication
(10) Pub. No.: US 2025/0310835 A1
(43) Pub. Date: Oct. 2, 2025

(54) COMMUNICATION DEVICE WITH DYNAMIC DATA RATE ADJUSTING MECHANISM AND DYNAMIC DATA RATE ADJUSTING METHOD THEREOF

(71) Applicant: MEDIATEK INC., Hsinchu City (TW)

(72) Inventors: Pei-Han Huang, Hsinchu City (TW); Jen-Chieh Liu, Hsinchu City (TW); Yung-Ting Tsai, Hsinchu City (TW); Kai-Hsiang Yang, Hsinchu City (TW)

(73) Assignee: MEDIATEK INC., Hsinchu City (TW)

(21) Appl. No.: 19/074,472

(22) Filed: Mar. 10, 2025

Related U.S. Application Data
(60) Provisional application No. 63/572,968, filed on Apr. 2, 2024.

(51) Int. Cl. H04W 28/22; H04W 48/08; H04W 76/15

(52) U.S. Cl. CPC H04W 28/22; H04W 48/08; H04W 76/15

(57) ABSTRACT

A communication device with a dynamic data rate adjusting mechanism and a dynamic data rate adjusting method thereof are provided. The communication device includes a first transceiver path circuit, a second transceiver path circuit and a controller. The controller executes first determination to determine whether one or more channel interference effects exist between a first signal transmitted on a first channel and a second signal transmitted on a second channel, and generate an interference determination result. The controller further executes second determination to determine whether communication between the communication device and the second linked device on the second channel should be executed through the first transceiver path circuit or the second transceiver path circuit, and whether to adjust the data rate of any of the first channel and the second channel according to the interference determination result, and executes corresponding controls according to a result of the second determination.

### CROSS REFERENCE TO RELATED APPLICATIONS

This application claims the benefit of U.S. Provisional Application No. 63/572,968, filed on Apr. 2, 2024. The content of the application is incorporated herein by reference.

### BACKGROUND

The present invention is related to multiple network applications, and more particularly, to a communication device with a dynamic data rate adjusting mechanism and a dynamic data rate adjusting method thereof, which is applicable to concurrent multiple networks scenarios.

There are increasing demands for multiple networks in recent applications. For example, a mobile device is linked to an access point (AP) and further projects a screen of the mobile device to a television. In another example, the mobile device is linked to the AP and further shares a soft-AP (e.g. a Wi-Fi hotspot) for another device. Thus, how to achieve better system performance under multiple networks becomes important issue. In particular, when a device (e.g., a mobile device) operates under these scenarios, signals of multiple channels of this device encounter some issues which result in data latency and/or throughput degrades. In a related art, certain technique(s) for overcoming these issues are applied to the device no matter which scenario is the device operates in, and therefore unnecessary power consumption may be generated in some scenarios.

Thus, there is a need for a novel control mechanism, which can ensure that the device can operate under an optimized configuration in response to a current operating scenario, to thereby improve an overall performance and efficiency.

### SUMMARY

An objective of the present invention is to provide a communication device with a dynamic data rate adjusting mechanism and a dynamic data rate adjusting method thereof, which can dynamically determine an optimized data rate of the communication device in response to a current operating scenario.

At least one embodiment of the present invention provides a communication device with a dynamic data rate adjusting mechanism. The communication device comprises a first transceiver path circuit, a second transceiver path circuit and a controller, wherein the controller is coupled to the first transceiver path circuit and the second transceiver path circuit. The first transceiver path circuit is configured to transmit or receive signals in a first band, and the second transceiver path circuit is configured to transmit or receive signals in a second band, wherein the controller is configured to detect the communication status between the communication device and a first linked device and a second linked device. When detecting that the communication device communicates with the first linked device on a first channel through the first transceiver path circuit and the communication device communicates with or intends to communicate with the second linked device on a second channel, the controller is further configured to execute a first determination to determine whether one or more channel interference effects exist between a first signal transmitted on the first channel and a second signal transmitted on the second channel, and generate an interference determination result. The controller is further configured to execute a second determination to determine whether the communication between the communication device and the second linked device on the second channel should be executed through the first transceiver path circuit or the second transceiver path circuit, and whether to adjust the data rate of at least one of the first channel and the second channel according to the interference determination result, and execute corresponding controls according to the result of the second determination.

At least one embodiment of the present invention provides a dynamic data rate adjusting method of a communication device. The communication device comprises a first transceiver path circuit for transmitting or receiving signals in a first band a first band and a second transceiver path circuit for transmitting or receiving signals in a second band, and further comprises a controller coupled to the first transceiver path circuit and the second transceiver path circuit. The method comprises: the controller detecting the communication status between the communication device and a first linked device and a second linked device; when detecting that the communication device communicates with the first linked device on a first channel through the first transceiver path circuit and the communication device communicates with or intends to communicate with the second linked device on a second channel, the controller further executing a first determination to determine whether one or more channel interference effects exist between a first signal transmitted on the first channel and a second signal transmitted on the second channel, and generating an interference determination result; the controller further executing a second determination to determine whether the communication between the communication device and the second linked device on the second channel should be executed through the first transceiver path circuit or the second transceiver path circuit, and whether to adjust the data rate of at least one of the first channel and the second channel according to the interference determination result; and the controller executing corresponding controls according to the result of the second determination.

The communication device and the dynamic data rate adjusting method provided by the embodiments of the present invention can dynamically adjust configuration of the communication device (e.g. the data rate mentioned above) in response to a current scenario. For example, the configuration can be adjusted in response to a specific issue of a multi-channel concurrent (MCC) scenario (e.g. an aliasing issue) being detected. Thus, the specific issue can be solved by properly adjusting the configuration. In addition, the embodiments will not greatly increase additional costs. Thus, the present invention can improve an overall performance and efficiency without introducing any side effect or in a way that is less likely to introduce side effects.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a communication device with a dynamic data rate adjusting mechanism according to an embodiment of the present invention.

FIG. 2 is a diagram illustrating determination of a channel spacing effect according to an embodiment of the present invention.

FIG. 3 is a diagram illustrating determination of an aliasing effect according to an embodiment of the present invention.

FIG. 4 is a diagram illustrating communication traffics when a communication device is linked with a first device according to an embodiment of the present invention.

FIG. 5 is a diagram illustrating communication traffics when a communication device with a fixed data rate is linked with a first device and a second device according to an embodiment of the present invention.

FIG. 6 is a diagram illustrating communication traffics when a communication device with a dynamic data rate is linked with a first device and a second device according to an embodiment of the present invention.

FIG. 7 is a diagram illustrating communication traffics when a second device is disconnected according to an embodiment of the present invention.

FIG. 8 is a diagram illustrating a working flow of a dynamic data rate adjusting method of a communication device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”.

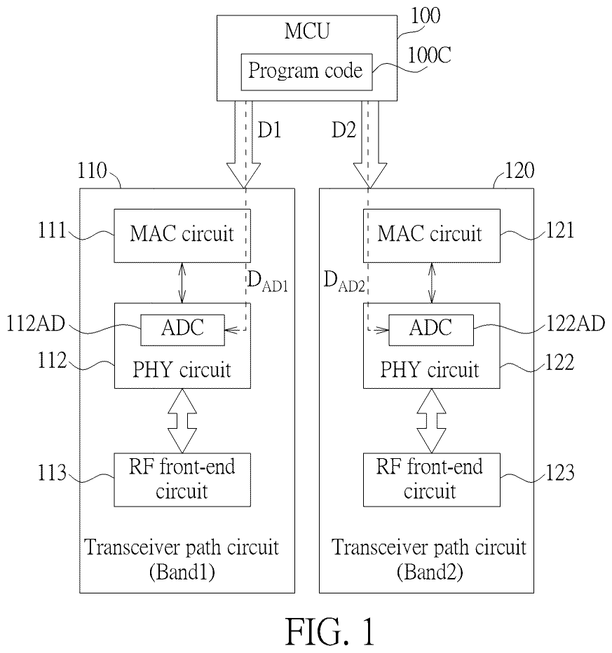

FIG. 1 is a diagram illustrating a communication device 10 with a dynamic data rate adjusting mechanism according to an embodiment of the present invention. As shown in FIG. 1, the communication device 10 comprises a first band circuit such as a transceiver path circuit 110 for a first band Band1 (the transceiver path circuit 110 transmits or receives signals in the first band), a second band circuit such as a transceiver path circuit 120 for a second band Band2 (the transceiver path circuit 120 transmits or receives signals in the second band), and a controller such as a microcontroller unit (MCU) 100, where the MCU 100 is coupled to the transceiver path circuits 110 and 120. The MCU 100 may control operations of the transceiver path circuits 110 and 120 through control signals D1 and D2, respectively, and more particularly, the MCU 100 may determine configurations of the transceiver path circuits 110 and 120 by software control according to a program code 100C. In detail, when the MCU detects the communication device 10 communicates with the first linked device on a first channel through the first transceiver path circuit 110 and the communication device 10 communicates with or intends to communicate with a second linked device on a second channel, the MCU 100 may determine whether one or more channel interference effects exist between a first signal transmitted on the first channel (e.g. the first signal is transmitted to the first linked device from the communication device 10 or transmitted to the communication device 10 from the first linked device) and a second signal transmitted on the second channel (e.g. the second signal is transmitted to the second linked device from the communication device 10 or transmitted to the communication device 10 from the second linked device), and generate an interference determination result. The MCU 100 may further determine whether the communication between the communication device 10 and the second linked device on the second channel should be executed through the first transceiver path circuit 110 or the second transceiver path circuit 120, whether to adjust the data rate of at least one of the first channel and the second channel according to the interference determination result, and executes corresponding controls according to the further determination.

In some embodiments, the first channel may be different from the second channel, when the MCU 100 determines the communication between the communication device 10 and the second linked device on the second channel should be executed through the first transceiver path circuit 110, the MCU 100 controls the communication between the communication device 10 and the first linked device on the first channel and the communication between the communication device 10 and the second linked device on the second channel to use the first transceiver path circuit 110 in a MCC mode. In the MCC mode, signals on the first channel and signals on the second channel are transmitted/received through TDD (Time Division Duplex).

In some embodiments, the first channel may be the same as the second channel, when the MCU 100 determines the communication between the communication device 10 and the second linked device on the second channel should be executed through the first transceiver path circuit 110, the MCU 100 controls the communication between the communication device 10 and the first linked device on the first channel, and the communication between the communication device 10 and the second linked device on the second channel to use the first transceiver path circuit 110 in a SCC (Single Channel Contention) mode. In the SCC mode, signals on the first channel and signals on the second channel are transmitted/received through TDD (Time Division Duplex) or FDD (Frequency Division Duplex).

In some embodiments, the first channel may be different from the second channel, when the MCU 100 determines the communication between the communication device 10 and the second linked device on the second channel should be executed through the second transceiver path circuit 120, the MCU 100 controls the communication between the communication device 10 and the first linked device on the first channel, and the communication between the communication device 10 and the second linked device on the second channel to use the first transceiver path circuit 110 and the second transceiver path circuit 120 in a DBDC (Dual Band Dual Concurrent) mode. In the DBDC mode, signals on the first channel and signals on the second channel are transmitted/received through FDD (Frequency Division Duplex).

In some embodiments, the MCU 100 may determines to increase the data rate of at least one of the first channel and the second channel.

In some embodiments, the transceiver path circuit 110 may comprise a media access control (MAC) circuit 111, a physical layer (PHY) circuit 112 and a radio frequency (RF) front-end circuit 113, and the transceiver path circuit 120 may comprise a MAC circuit 121, a PHY circuit 122 and a RF front-end circuit 123, where the data rate mentioned above is a data rate of an analog-to-digital converter (ADC) within at least one of the transceiver path circuits 110 and 120 (e.g. an ADC 112AD within the PHY circuit 112 of the transceiver path circuit 110 or an ADC 122AD within the PHY circuit 122 of the transceiver path circuit 120). For example, the MCU 100 may determine whether to adjust a data rate of the ADC 112AD according to the interference determination result. In another example, the MCU 100 may determine whether to adjust a data rate of the ADC 122AD according to the interference determination result.

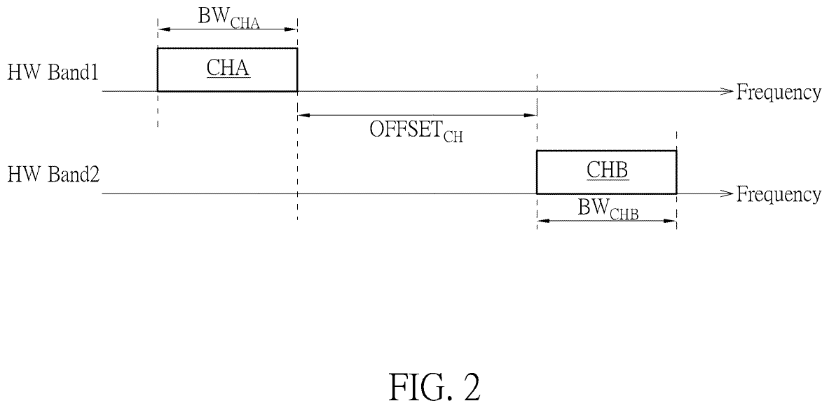

In some embodiments, one of the channel interference effects may comprise a channel spacing effect (may also called “isolation issue”) between the first signal transmitted on the first channel and the second signal transmitted on the second channel, where FIG. 2 is a diagram illustrating determination of a channel spacing effect according to an embodiment of the present invention. As shown in FIG. 2, the first signal is transmitted on a channel CHA (which has a bandwidth BWCHA) and the second signal is transmitted on a channel CHB (which has a bandwidth BWCHB) are respectively transmitted on the first band circuit (labeled “HW Band1” in FIG. 2 for brevity) such as the transceiver path circuit 110 and the second band circuit (labeled “HW Band2” in FIG. 2 for brevity) such as the transceiver path circuit 120. The MCU 100 may calculate a channel offset OFFSET_{CH} between the channel CHA and CHB (e.g. a frequency difference between an upper bound of the channel CHA and a lower bound of the channel CHB), and determine whether the channel offset OFFSET_{CH} between the channel CHA and CHB is greater than a predetermined offset threshold. When the channel offset OFFSET_{CH} is not less than the predetermined offset threshold, the MCU 100 may determine that the channel spacing effect is not detected. When the channel offset OFFSET_{CH} is less than the predetermined offset threshold, the MCU 100 may determine that the channel spacing effect is detected. Under 5G/5G channel concurrent scenario, the predetermined offset threshold may be 160 MHz, and for 5G/6G channel concurrent scenario, the predetermined offset threshold may be 190 MHZ, but the present invention is not limited thereto. It should be noted that, the channel CHA and CHB are located in different bands is just an example, the method of the determination of a channel spacing effect illustrated here may also adapted to other situation, for example in a situation that the channel CHA (which has a bandwidth BWCHA) and the channel CHB (which has a bandwidth BWCHB) are in the same band. Besides, the method of FIG. 2 may be implemented in a simulation scenario, a test scenario, or a normal communication scenario.

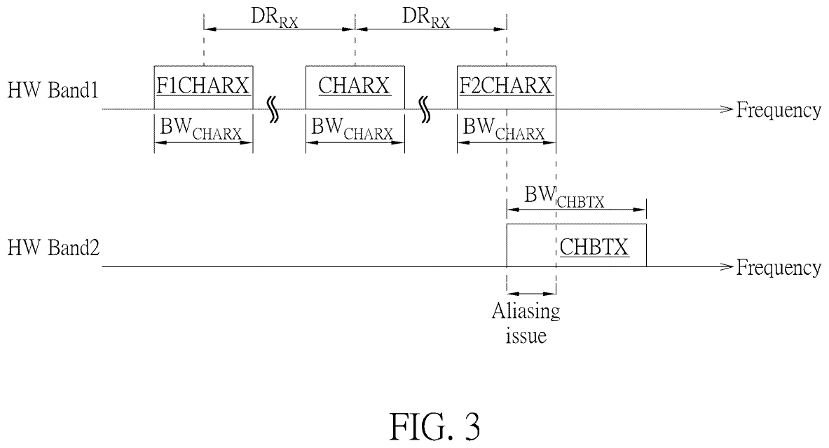

In some embodiments, one of the channel interference effects may comprise an aliasing effect (may also called “aliasing issue”) between the first signal transmitted on the first channel and the second signal transmitted on the second channel, where FIG. 3 is a diagram illustrating determination of an aliasing effect according to an embodiment of the present invention. As shown in FIG. 3, the first signal is transmitted on a channel CHARX (which has a bandwidth BW_{CHARX}) and may be received by the first band circuit (labeled “HW Band1” in FIG. 3 for brevity), and the second signal is transmitted on a channel CHBTX (which has a bandwidth BW_{CHBTX}) may be transmitted by the second band circuit (labeled “HW Band2” in FIG. 3 for brevity). In addition, a forbidden range F1CHARX introduced by the channel CHARX may be at a lower sideband of the channel CHARX, and a forbidden range F2CHARX introduced by the channel CHARX may be at an upper sideband of the channel CHARX. In this embodiment, DR_{RX} may represent a data rate of the ADC 112AD or 122AD, and may be set to be 4×BW_{CHARX}, but the present invention is not limited thereto, where a frequency difference between a center frequency of the channel CHARX and a center frequency of the forbidden range F1CHARX may be DR_{RX} (e.g. 4×BW_{CHARX}), and a frequency difference between the center frequency of the channel CHARX and a center frequency of the forbidden range F2CHARX may be DR_{RX} (e.g. 4×BW_{CHARX}). In detail, the MCU 100 may determine whether the channel CHBTX overlaps any of the forbidden ranges F1CHARX and F2CHARX, and when the channel CHBTX overlaps any of the forbidden ranges F1CHARX and F2CHARX, the MCU 100 may determine that the aliasing effect is detected. It should be noted that, the channel CHARX and CHBTX are located in different bands is just an example, the method of the determination of an aliasing effect illustrated here may also adapted to other situations, for example in a situation that the channel CHARX (which has a bandwidth BW_{CHARX}) and the channel CHBTX (which has a bandwidth BW_{CHBTX}) are in the same band. Besides, the method of FIG. 3 may be implemented in a simulation scenario, a test scenario, or a normal communication scenario.

In detail, the MCU 100 may determine whether the aliasing effect is detected according to a first bandwidth of the first signal (e.g. the bandwidth BW_{CHARX} of the channel CHARX), a second bandwidth of the second signal (e.g. the bandwidth BW_{CHBTX} of the channel CHBTX), and a channel spacing between the first signal and the second signal (e.g. a channel spacing between the channel CHARX and CHBTX, which may be a frequency difference between a center frequency of the channel CHARX and a center frequency of the channel CHBTX). In particular, the MCU 100 may determine whether the aliasing effect is detected according to whether the channel spacing between the channels CHARX and CHBTX is less than “DR_{RX}+(½)×BW_{CHARX}+(½)×BW_{CHBTX}” (e.g. “(4×BW_{CHARX})+((½)×BW_{CHARX}+(½)×BW_{CHBTX}”). When the MCU 100 determines that the channel spacing between the channels CHARX and CHBTX is not less than “DR_{RX}+((½)×BW_{CHARX}+(½)×BW_{CHBTX}”, which means that the channel CHBTX does not overlap the forbidden range F2CHARX, the MCU 100 may determine that the aliasing effect is not detected. The MCU 100 may further determine whether the aliasing effect is detected according to whether the channel spacing between the channels CHARX and CHBTX is greater than “DR_{RX}−((½)×BW_{CHARX}+(½)×BW_{CHBTX}” (e.g. “(4×BW_{CHARX})−(½)×BW_{CHARX}+(½)×BW_{CHBTX}”). When the MCU 100 determines that the channel spacing between the channels CHARX and CHBTX is not greater than “DR_{RX}−((½)×BW_{CHARX}+(½)×BW_{CHBTX}”, which means that the channel CHBTX does not overlap the forbidden range F2CHARX, the MCU 100 may determine that the aliasing effect is not detected. However, when the MCU 100 determines that the channels CHARX and CHBTX is less than “DR_{RX}+((½)×BW_{CHARX}+(½)×BW_{CHBTX}” and is greater than “DR_{RX}−((½)×BW_{CHARX}+(½)×BW_{CHBTX}”, which means that the channel CHBTX overlaps the forbidden range F2CHARX, the MCU 100 may determine that the aliasing effect is detected.

In some embodiments, the interference determination result may indicate whether the aliasing effect is detected. In some embodiments, the interference determination result may further indicate whether the channel spacing effect is detected. In addition, in some embodiments, the MCU 100 may determine a present scenario according to the interference determination result, and even to generate a scenario identifier (ID).

In some embodiments, an original value of the data rate DR_{RX} is determined according to at least one of the first bandwidth and the second bandwidth (e.g. an original value of the data rate DR_{RX} of the ADC 112AD may be set as 4×BW_{CHARX}) when the communication device 10 communicates with the first linked device on the channel CHARX through the first transceiver path circuit 110 and the second linked device hasn't linked with the communication device 10, or when the communication device 10 communicates with the first linked device on the channel CHARX through the first transceiver path circuit 110 and the communication device 10 communicates with the second linked device on the channel CHATX through the first transceiver path circuit 110 or the second transceiver path circuit 120. The MCU 100 may determine whether to increase the data rate DR_{RX} to an adjusted value (e.g. 8×BW_{CHARX}) greater than the original value according to the interference determination result.

In some embodiments, when the MCU 100 detects that the communication device 10 communicates with the first linked device on a first channel through the first transceiver path circuit 110 and the communication device 10 communicates with a second linked device on a second channel through any of the first transceiver path circuit 110 and the second transceiver path circuit 120, and the interference determination result (e.g. the scenario ID) indicates that the aliasing effect is not detected (no matter whether the channel spacing effect is detected or not), the MCU 100 may determine not to adjust the data rate of both of the first channel and the second channel, and thus keep the data rate of both of the first channel and the second channel. For example, the MCU 100 may keep the data rate DR_{RX} at the original value (e.g. 4×BW_{CHARX}). Besides, the MCU 100 may determine that the communication between the communication device 10 and the second linked device on the second channel should still be executed through the first transceiver path circuit 110/the second transceiver path circuit 120, and thus keeps the communication between the communication device 10 and the second linked device on the second channel. As mentioned before, if the communication between the communication device 10 and the first linked device on the first channel is executed through the first transceiver path circuit 110, and the communication between the communication device 10 and the second linked device on the second channel is executed through the first transceiver path circuit 110, the first channel and the second channel may use the first transceiver path circuit 110 in a SCC mode or MCC mode according to whether the first channel and the second channel is the same as each other. Besides, if the communication between the communication device 10 and the first linked device on the first channel is executed through the first transceiver path circuit 110, and the communication between the communication device 10 and the second linked device on the second channel is executed through the second transceiver path circuit 120, the first channel and the second channel may use the first transceiver path circuit 110 and the second transceiver path circuit 120 in a DBDC mode.

In some embodiments, when the MCU 100 determines that the communication device 10 communicates with the first linked device on a first channel through the first transceiver path circuit 110 and the communication device 10 intends to communicate with a second linked device on a second channel, and the interference determination result (e.g. the scenario ID) indicates that the aliasing effect is not detected (no matter whether the channel spacing effect is detected or not), the MCU 100 may determine not to adjust the data rate of both of the first channel and the second channel, and thus keep the data rate of both of the first channel and the second channel. For example, the MCU 100 may keep the data rate DR_{RX} at the original value (e.g. 4×BW_{CHARX}). Besides, the MCU 100 may determine that the communication between the communication device 10 and the second linked device on the second channel should be executed through the first transceiver path circuit 110/the second transceiver path circuit 120, and thus controls the communication between the communication device 10 and the second linked device on the second channel to be executed through the first transceiver path circuit 110/the second transceiver path circuit 120. As mentioned before, if the communication between the communication device 10 and the first linked device on the first channel is executed through the first transceiver path circuit 110, and the communication between the communication device 10 and the second linked device on the second channel is executed through the first transceiver path circuit 110, the first channel and the second channel may use the first transceiver path circuit 110 in a SCC mode or MCC mode according to whether the first channel and the second channel is the same as each other. Besides, if the communication between the communication device 10 and the first linked device on the first channel is executed through the first transceiver path circuit 110, and the communication between the communication device 10 and the second linked device on the second channel is executed through the second transceiver path circuit 120, the first channel and the second channel may use the first transceiver path circuit 110 and the second transceiver path circuit 120 in a DBDC mode.

In one embodiment, when the MCU 100 determines that the communication device 10 communicates with the first linked device on a first channel through the first transceiver path circuit 110 and the communication device 10 communicates with a second linked device on a second channel through the first transceiver path circuit 110 (e.g. the two communication is in MCC mode), and the interference determination result indicates that the aliasing effect is detected and the channel spacing effect is not detected (e.g. the channel offset OFFSET_{CH} between the channels CHA and CHB is greater than the predetermined offset threshold), the MCU 100 determine to increase the data rate of at least one of the first channel and the second channel, and thus increase the data rate of at least one of the first channel and the second channel, for example, the MCU 100 may increase the data rate of DR_{RX} the channel signals CHA to the adjusted value (e.g. 8×BW_{CHARX}). Besides, the MCU 100 may determine that the communication between the communication device 10 and the second linked device on the second channel should be executed through the second transceiver path circuit 120, and thus controls the communication between the communication device 10 and the second linked device on the second channel to be executed through the second transceiver path circuit 120. As mentioned before, if the communication between the communication device 10 and the first linked device on the first channel is executed through the first transceiver path circuit 110, and the communication between the communication device 10 and the second linked device on the second channel is executed through the second transceiver path circuit 120, the first channel and the second channel may use the first transceiver path circuit 110 and the second transceiver path circuit 120 in a DBDC mode. Thus, in these embodiments, when the interference determination result indicates that the aliasing effect is detected and the channel spacing effect is not detected, MCC mode is adjusted to DBDC mode and the data rate of the at least one channel is increased.

In some embodiments, when the MCU 100 detects that the second linked device is disconnected from the communication device 10 and only the first signal still exists, the MCU 100 may switch the data rate of the first channel (e.g. the data rate DR_{RX}) back to the original value (e.g. 4×BW_{CHARX}).

In one embodiment, when the MCU 100 determines that the communication device 10 communicates with the first linked device on a first channel through the first transceiver path circuit 110 and the communication device 10 intends to communicate with a second linked device on a second channel, and the interference determination result indicates that the aliasing effect is detected and the channel spacing effect is not detected (e.g. the channel offset OFFSET_{CH} between the channels CHA and CHB is greater than the predetermined offset threshold), the MCU 100 determine to increase the data rate of at least one of the first channel and the second channel, and thus increase the data rate of at least one of the first channel and the second channel, for example, the MCU 100 may increase the data rate of DR_{RX} the channel signals CHA to the adjusted value (e.g. 8×BW_{CHARX}). Besides, the MCU 100 may determine that the communication between the communication device 10 and the second linked device on the second channel should be executed through the second transceiver path circuit 120, and thus controls the communication between the communication device 10 and the second linked device on the second channel to be executed through the second transceiver path circuit 120. As mentioned before, if the communication between the communication device 10 and the first linked device on the first channel is executed through the first transceiver path circuit 110, and the communication between the communication device 10 and the second linked device on the second channel is executed through the second transceiver path circuit 120, the first channel and the second channel may use the first transceiver path circuit 110 and the second transceiver path circuit 120 in a DBDC mode. Thus, in these embodiments, when the interference determination result indicates that the aliasing effect is detected and the channel spacing effect is not detected, a DBDC mode is determined and implemented by the MCU 100 and the data rate of the at least one channel is increased.

In some embodiments, when the MCU 100 determines that the communication device 10 communicates with the first linked device on a first channel through the first transceiver path circuit 110 and the communication device 10 communicates with a second linked device on a second channel through the first transceiver path circuit 110 (e.g. the two communication is in MCC mode), and the interference determination result (e.g. the scenario ID) indicates the aliasing effect is not detected and the channel spacing effect is detected (e.g. the channel offset OFFSET_{CH} between the channels CHA and CHB is less than the predetermined offset threshold), the MCU 100 may determine not to adjust the data rate of both of the first channel and the second channel, and thus keep the data rate of both of the first channel and the second channel. For example, the MCU 100 may keep the data rate DR_{RX} at the original value (e.g. 4×BW_{CHARX}). Besides, the MCU 100 may determine that the communication between the communication device 10 and the second linked device on the second channel should still be executed through the first transceiver path circuit 110, and thus keeps the communication through the first transceiver path circuit 110.

In one embodiment, when the MCU 100 determines that the communication device 10 communicates with the first linked device on a first channel through the first transceiver path circuit 110 and the communication device 10 intends to communicate with a second linked device on a second channel, when the interference determination result indicates that the aliasing effect is detected and the channel spacing effect is detected, the MCU 100 may determine not to adjust the data rate of both of the first channel and the second channel, and thus keep the data rate of both of the first channel and the second channel. For example, the MCU 100 may keep the data rate DR_{RX} at the original value (e.g. 4×BW_{CHARX}). Besides, the MCU 100 may determine that the communication between the communication device 10 and the second linked device on the second channel should be executed through the first transceiver path circuit 110, and thus controls the communication between the communication device 10 and the second linked device on the second channel to be executed through the first transceiver path circuit 110. As mentioned before, if the communication between the communication device 10 and the first linked device on the first channel is executed through the first transceiver path circuit 110, and the communication between the communication device 10 and the second linked device on the second channel is executed through the first transceiver path circuit 110, the first channel and the second channel may use the first transceiver path circuit 110 in a SCC mode or MCC mode according to whether the first channel and the second channel is the same as each other. Thus, in these embodiments, when the interference determination result indicates that the aliasing effect is detected and the channel spacing effect is detected, a MCC mode or SCC mode is determined and implemented by the MCU 100 and the data rate of the at least one channel isn't adjusted.

TABLE 1

| Scenario | | Default | |
|---|---|---|---|
| ID | Present scenario | configuration | Final configuration |
| SID 1 | STA and P2P in | DR_{RX} = 320 MHz | DR_{RX} = 320 MHz |
| | DBDC mode | DBDC mode (FDD) | DBDC mode (FDD) |
| | Without aliasing | | |
| | effect | | |
| | Without channel | | |
| | spacing effect | | |
| SID2 | STA and P2P in | DR_{RX} = 320 MHz | DR_{RX} = 320 MHz |
| | SCC mode | SCC mode (FDD) | SCC mode (FDD) |
| | Without aliasing | | |
| | effect | | |
| | Without channel | | |
| | spacing effect | | |
| SID3 | STA and P2P in | DR_{RX} = 320 MHz | DR_{RX} = 320 MHz |
| | MCC mode | MCC mode (TDD) | MCC mode (TDD) |
| | Without aliasing | | |
| | effect | | |
| | With channel | | |
| | spacing effect | | |
| SID4 | STA and P2P in | DR_{RX} = 320 MHz | DR_{RX} = 640 MHz |
| | MCC mode | MCC mode (TDD) | DBDC mode (FDD) |
| | With aliasing | | |
| | effect | | |
| | Without channel | | |
| | spacing effect | | |
| SID5 | STA and P2P in | DR_{RX} = 160 MHz | DR_{RX} = 160 MHz |
| | MCC mode | MCC mode (TDD) | MCC mode (TDD) |
| | With aliasing | | |
| | effect | | |
| | With channel | | |
| | spacing effect | | |

Table 1 illustrates configurations of the communication device 10 with respect to different scenarios. Assume that the communication device 10 (e.g. a STA device) is linked with an access point (AP) device and further linked with a reference device (e.g. another STA device) via peer-to-peer (P2P) communication. In a first scenario (e.g. the scenario ID is SID1), the communication device 10 communicates with the AP device and the reference device in a dual band dual concurrent (DBDC) mode with a FDD operation and the data rate DR_{RX} is set to 320 MHz (e.g. when the bandwidth BW_{CHARX}=80 MHZ) under a default configuration, when the MCU 100 determines that the aliasing effect and the channel spacing effect are not detected, and the MCU 100 therefore keeps the configuration of the communication device 10 unchanged (e.g. keeps in the FDD operation with DR_{RX}=320 MHz) as shown in a final configuration. In a second scenario (e.g. the scenario ID is SID2), the communication device 10 communicates with the AP device and the reference device in a single channel concurrent (SCC) mode with the FDD operation and the data rate DR_{RX} is set to 320 MHz (e.g. when the bandwidth BW_{CHARX}=80 MHZ) under the default configuration, where the MCU 100 determines that the aliasing effect and the channel spacing effect are not detected, and the MCU 100 therefore keeps the configuration of the communication device 10 unchanged (e.g. keeps in the FDD operation with DR_{RX}=320 MHz) as shown in the final configuration. In a third scenario (e.g. the scenario ID is SID3), the communication device 10 communicates with the AP device and the reference device in a multi-channel concurrent (MCC) mode with a TDD operation and the data rate DR_{RX} is set to 320 MHz (e.g. when the bandwidth BW_{CHARX}=80 MHZ) under the default configuration, where the MCU 100 determines that the aliasing effect is not detected but the channel spacing effect is detected, and the MCU 100 therefore keeps the configuration of the communication device 10 unchanged (e.g. keeps in the TDD operation with DR_{RX}=320 MHz) as shown in the final configuration. In a fourth scenario (e.g. the scenario ID is SID4), the communication device 10 communicates with the AP device and the reference device in the MCC mode with the TDD operation and the data rate DR_{RX} is set to 320 MHz (e.g. when the bandwidth BW_{CHARX}=80 MHZ) under the default configuration, where the MCU 100 determines that the aliasing effect is detected but the channel spacing effect is not detected, and the MCU 100 therefore adjusts the data rate DR_{RX} (e.g. increasing to 640 MHz) and switches the MCC mode with the TDD operation to the DBDC mode with the FDD operation (which results in throughput enhancement and latency reduction) as shown in the final configuration. In a fifth scenario (e.g. the scenario ID is SID5), the communication device 10 communicates with the AP device and the reference device in the MCC mode with the TDD operation and the data rate DR_{RX} is set to 160 MHz (e.g. when the bandwidth BW_{CHARX}=40 MHz) under the default configuration, where the MCU 100 determines that the aliasing effect and the channel spacing effect are detected, and the MCU 100 therefore keeps the configuration of the communication device 10 unchanged (e.g. keeps in the TDD operation with DR_{RX}=320 MHz) as shown in the final configuration.

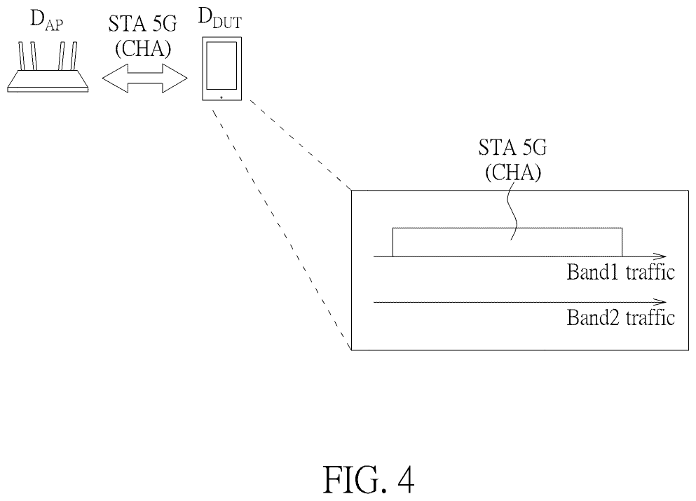

FIG. 4 is a diagram illustrating communication traffics when a communication device D_{DUT} (which may be an example of the communication device 10) function as a STA is linked with a first device such as an AP device DAP (which may be an example of the first linked device mentioned above) according to an embodiment of the present invention. As shown in FIG. 4, the communication device D_{DUT} may communicate with the AP device DAP on a station-based 5G channel, and more particularly, the channel signal CHA may be received from the AP device DAP or transmitted to the AP device DAP through the station-based 5G channel (labeled “STA 5G (CHA)” in FIG. 4 for better comprehension). As the communication device D_{DUT} is linked with the AP device DAP only, resources of the transceiver path circuit 110 can be fully utilized by the channel signal CHA, as illustrated by Band1 traffic, where the transceiver path circuit 120 is idle as illustrated by Band 2 traffic.

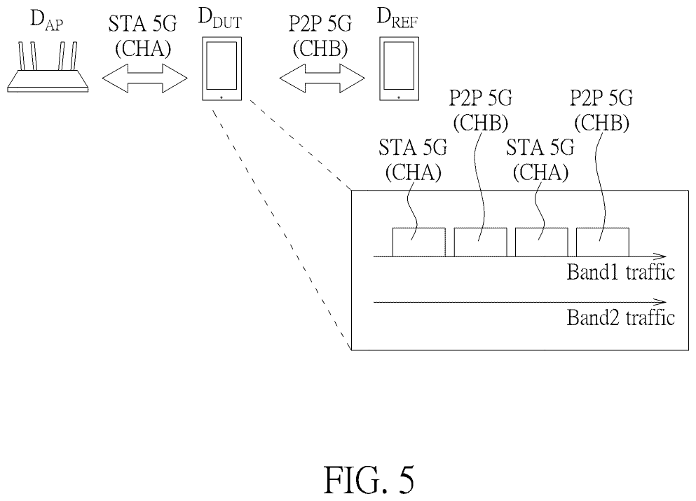

FIG. 5 is a diagram illustrating communication traffics when the communication device D_{DUT} with a fixed data rate is linked with a first device (e.g. the AP device DAP) and a second device (e.g. a reference device DREF) according to an embodiment of the present invention. In comparison with the embodiment of FIG. 4, the reference device DREF (which may be an example of the second linked device mentioned above) is further added into a network of the communication device D_{DUT}, where the communication device D_{DUT} may further communicate with the reference device DREF on a P2P-based 5G channel, and more particularly, the channel signal CHB may be received from the reference device DREF or transmitted to the reference device DREF through the P2P-based 5G channel (labeled “P2P 5G (CHA)” in FIG. 5 for better comprehension). As the communication device D_{DUT} is linked with the AP device DAP and the reference device DREF concurrently, when the aliasing effect between the channel signals CHA and CHB are detected, operations of the station-based 5G channel and the P2P-based 5G channel of the communication device D_{DUT} is be performed in the TDD mode without adjusting the data rate DR_{RX} (e.g. being fixed at 320 MHz) as illustrated by the Band1 traffic, thereby resulting in degrade of throughput and additional latency.

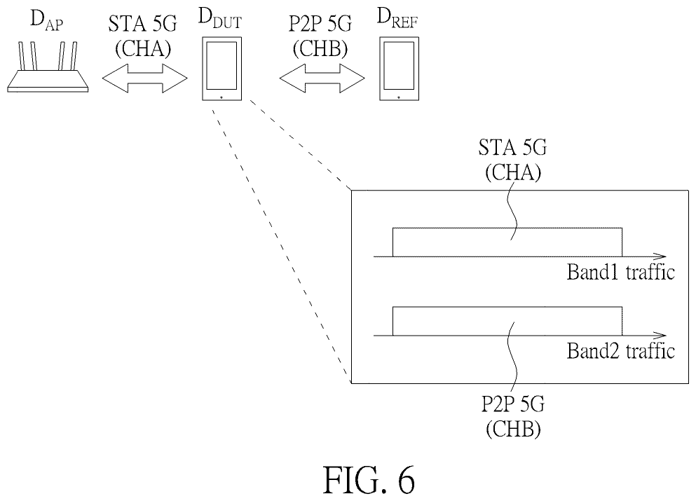

FIG. 6 is a diagram illustrating communication traffics when the communication device D_{DUT} with a dynamic data rate is linked with a first device (e.g. the AP device DAP) and a second device (e.g. a reference device DREF) according to an embodiment of the present invention. In comparison with the embodiment of FIG. 5, the data rate DR_{RX} of CHA or CHB is increased (e.g. increased to 640 MHz) in response to the reference device DREF being further added into the network of the communication device D_{DUT} in order to solve the problem of the aliasing effect. Thus, the operations of the station-based 5G channel and the P2P-based 5G channel of the communication device D_{DUT} can be performed in the DBDC mode through FDD, where resources of the transceiver path circuit 110 can be fully utilized by the channel signal CHA as illustrated by the Band1 traffic, and resources of the transceiver path circuit 120 can be fully utilized by the channel signal CHB as illustrated by the Band2 traffic, thereby enhancing throughput and reducing latency of the communication device D_{DUT} in comparison with the embodiment of FIG. 5.

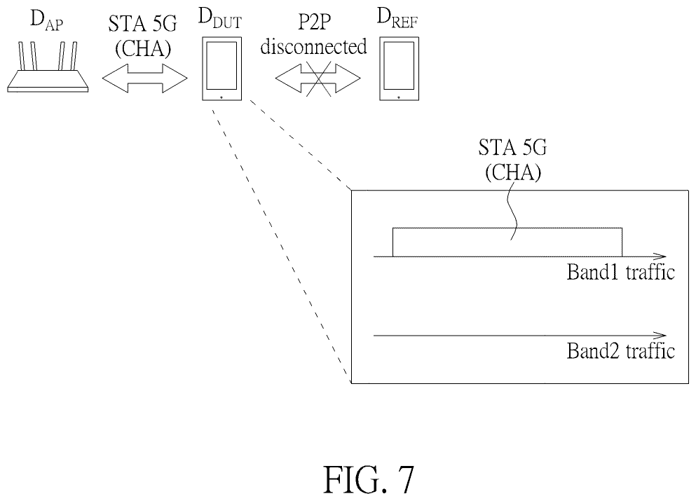

FIG. 7 is a diagram illustrating communication traffics when the second device (e.g. a reference device DREF) is disconnected according to an embodiment of the present invention. In particular, when the communication device D_{DUT} detects that the reference device DREF is disconnected, the MCU 100 within the communication device D_{DUT} may switch the data rate DR_{RX} of CHA back to 320 MHz to avoid unnecessary power consumption, and resources of the transceiver path circuit 110 can be fully utilized by the channel signal CHA as illustrated by the Band1 traffic.

It should be noted that the above embodiment takes station-based 5G connection and P2P connection as an example of the network of the communication device D_{DUT} (or the communication device 10), but the present invention is not limited thereto. In some embodiment, the communication device D_{DUT} (or the communication device 10) may communicate with other devices through other types of connection such as SAP connection and near-me area network (NAN) connection. As long as the MCU 100 within the communication device D_{DUT} (or the communication device 10) can dynamically adjust the data rate DR_{RX} of the ADC 112AD or 122AD in response to detection of multiple devices being linked, in order to enable communication associated with the multiple devices to performed in the FDD mode, these alternative designs should belong to the scope of the present invention.

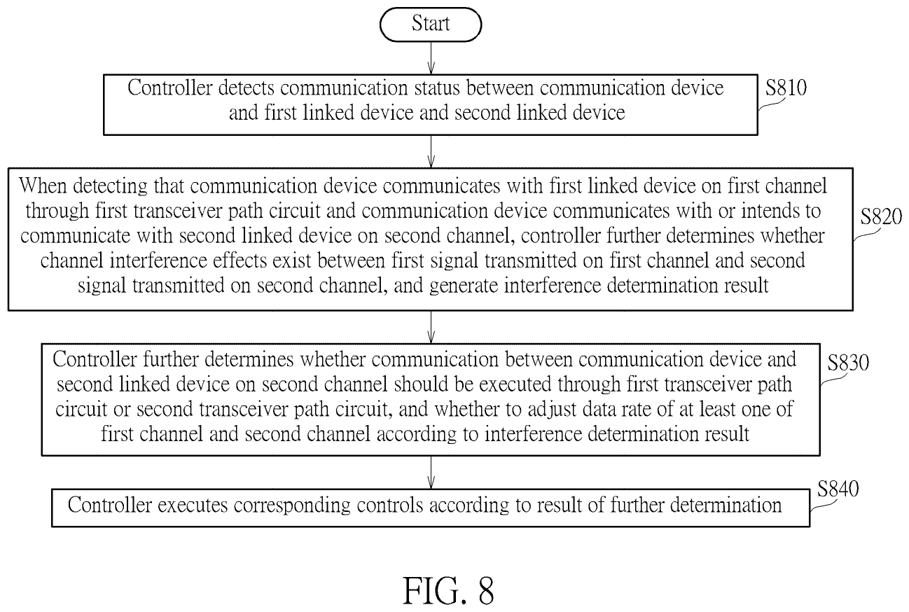

FIG. 8 is a diagram illustrating a working flow of a dynamic data rate adjusting method of a communication device (e.g. the communication device 10 shown in FIG. 1) according to an embodiment of the present invention. It should be noted that the working flow shown in FIG. 8 is for illustrative purposes only, and is not meant to be a limitation of the present invention. For example, one or more steps may be added, deleted or modified in the working flow shown in FIG. 8. In addition, if a same result can be obtained, these steps do not have to be executed in the exact order shown in FIG. 8.

In Step S810, a controller detects the communication status between a communication device (e.g. the communication device 10 shown in FIG. 1) and a first linked device and a second linked device.

In Step S820, when detecting that the communication device communicates with the first linked device on a first channel through the first transceiver path circuit and the communication device communicates with or intends to communicate with the second linked device on a second channel, the controller further determines whether one or more channel interference effects exist between a first signal transmitted on the first channel and a second signal transmitted on the second channel, and generate an interference determination result.

In Step S830, the controller further determines whether the communication between the communication device and the second linked device on the second channel should be executed through the first transceiver path circuit or the second transceiver path circuit, and whether to adjust the data rate of at least one of the first channel and the second channel according to the interference determination result.

In Step S840, the controller executes corresponding controls according to the result of the further determination.

To summarize, the communication device 10 and associated dynamic data rate adjusting method provided by the embodiments of the present invention can dynamically adjust the data rate DR_{RX} of the ADC 112AD or 122AD (e.g., can increase the data rate DR_{RX} of the ADC 112AD or 122AD) and dynamically control the communication mode (e.g., SCC mode, MCC mode, DBDC mode) of the communication device in response to a specific scenario (e.g. a condition where the aliasing effect is detected but the channel spacing is not detected). In addition, when the device causing the aliasing effect is disconnected, the data rate DR_{RX} can be switched back to the original value to save power consumption. Thus, the present invention enables the communication device operates in different modes to enhance throughput and reduce latency without greatly increase additional costs (e.g. power consumption).

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A communication device with a dynamic data rate adjusting mechanism, comprising:
a first transceiver path circuit, configured to transmit or receive signals in a first band;
a second transceiver path circuit, configured to transmit or receive signals in a second band; and
a controller, coupled to the first transceiver path circuit and the second transceiver path circuit, configured to detect the communication status between the communication device and a first linked device and a second linked device;
wherein when detecting that the communication device communicates with the first linked device on a first channel through the first transceiver path circuit and the communication device communicates with or intends to communicate with the second linked device on a second channel, the controller is further configured to execute a first determination to determine whether one or more channel interference effects exist between a first signal transmitted on the first channel and a second signal transmitted on the second channel, and generate an interference determination result;
wherein the controller is further configured to execute a second determination to determine whether the communication between the communication device and the second linked device on the second channel should be executed through the first transceiver path circuit or the second transceiver path circuit, and whether to adjust the data rate of at least one of the first channel and the second channel according to the interference determination result, and execute corresponding controls according to the result of the second determination.

2. The communication device of claim 1, wherein the one or more channel interference effects comprise an aliasing effect between the first signal and the second signal.

3. The communication device of claim 2, wherein:
when detecting that the communication device communicates with the first linked device on the first channel through the first transceiver path circuit and the communication device communicates with the second linked device on a second channel through any of the first transceiver path circuit and the second transceiver path circuit and the interference determination result indicates that the aliasing effect does not exist, the result of the second determination is not to adjust the data rate of both of the first channel and the second channel and not to adjust the communication between the communication device and the second linked device; and
the controller is further configured to keep the data rate of both of the first channel and the second channel and keeps the communication between the communication device and the second linked device according to the result of the second determination.

4. The communication device of claim 2, wherein:
when detecting that the communication device communicates with the first linked device on the first channel through the first transceiver path circuit and the communication device intends to communicates with the second linked device on a second channel, and the interference determination result indicates that the aliasing effect does not exist, the result of the second determination is not to adjust the data rate of both of the first channel and the second channel and the communication between the communication device and the second linked device on the second channel should be executed through the first or second transceiver path circuit; and
the controller is further configured to keep the data rate of both of the first channel and the second channel and control the communication between the communication device and the second linked device on the second channel to be executed through the first or second transceiver path circuit according to the result of the second determination.

5. The communication device of claim 2, wherein the controller determines whether the aliasing effect exists according to the first channel, the second channel, and a forbidden range between the first channel and the second channel, and when the controller determines the second bandwidth overlaps the forbidden range, the interference determination result indicates that the aliasing effect exists, otherwise the interference determination result indicates that the aliasing effect does not exist.

6. The communication device of claim 2, wherein the controller determines whether the aliasing effect exists according to the data rate of at least one of the first channel and the second channel, the first channel, the second channel, and a channel spacing between the first channel and the second channel, and when the controller determines the channel spacing satisfies equation (1), the interference determination result indicates that the aliasing effect does not exist, otherwise the interference determination result indicates that the aliasing effect exists;
wherein the equation (1) is:
Channel Spacing≥data rate+½ first bandwidth of the first channel+½ second bandwidth of the second channel; or
Channel Spacing≤data rate−(½ first bandwidth of the first channel+½ second bandwidth of the second channel).

7. The communication device of claim 2, wherein the one or more channel interference effects further comprise a channel spacing effect between the first signal and the second signal.

8. The communication device of claim 7, wherein:
when detecting that the communication device communicates with the first linked device on the first channel through the first transceiver path circuit and the communication device communicates with the second linked device on the second channel through the first transceiver path circuit, and the interference determination result indicates that the aliasing effect is detected and the channel spacing effect is not detected, the result of the second determination is to increase the data rate of at least one of the first channel and the second channel, and the communication between the communication device and the second linked device on the second channel should be executed through the second transceiver path circuit; and
the controller is further configured to increase the corresponding data rate and controls the communication between the communication device and the second linked device on the second channel to be executed through the second transceiver path circuit according to the result of the second determination.

9. The communication device of claim 8, wherein when the communication device communicates with the first linked device on the first channel through the first transceiver path circuit and the communication device communicates with the second linked device on the second channel through the first transceiver path circuit, the first channel and the second channel use the first transceiver path circuit in a Multi-Channel Concurrent (MCC) mode; and
when the communication device communicates with the first linked device on the first channel through the first transceiver path circuit and the communication device communicates with the second linked device on the second channel through the second transceiver path circuit, the first channel and the second channel use the first transceiver path circuit and the second transceiver path circuit in a Dual band Dual Concurrent (DBDC) mode.

10. The communication device of claim 7, wherein:
when detecting that the communication device communicates with the first linked device on the first channel through the first transceiver path circuit and the communication device intends to communicates with the second linked device on a second channel, and the interference determination result indicates that the aliasing effect is detected and the channel spacing effect is not detected, the result of the second determination is to increase the data rate of at least one of the first channel and the second channel, and the communication between the communication device and the second linked device on the second channel should be executed through the second transceiver path circuit; and
the controller is further configured to increase the corresponding data rate and controls the communication between the communication device and the second linked device on the second channel to be executed through the second transceiver path circuit according to the result of the second determination.

11. The communication device of claim 10, wherein when the communication device communicates with the first linked device on the first channel through the first transceiver path circuit and the communication device communicates with the second linked device on the second channel through the second transceiver path circuit, the first channel and the second channel use the first transceiver path circuit and the second transceiver path in a Dual band Dual Concurrent (DBDC) mode.

12. The communication device of claim 10, wherein when the controller detects that the second linked device is disconnected from the communication device, the controller switches the at least one of the data rates of the first signal and the second signal back to an original value, the original value is a value before the increase.

13. The communication device of claim 7, wherein:
when detecting that the communication device communicates with the first linked device on the first channel through the first transceiver path circuit and the communication device communicates with the second linked device on the second channel through the first transceiver path circuit, and the interference determination result indicates that the aliasing effect is detected and the channel spacing effect is detected, the result of the second determination is not to adjust the data rate of both of the first channel and the second channel and not to adjust the communication between the communication device and the second linked device; and
the controller is further configured to keep the data rate of both of the first channel and the second channel and keeps the communication between the communication device and the second linked device according to the result of the second determination.

14. The communication device of claim 7, wherein the controller determines whether the channel spacing effect exists according to the first channel and the second channel and when the controller determines the channel offset between the upper bound of first channel and a lower bound of the second channel is less than a predetermined offset, the interference determination result indicates that the channel spacing effect exists, otherwise the interference determination result indicates that the channel spacing effect does not exist.

15. The communication device of claim 1, wherein the data rate is a data rate of an analog-to-digital converter (ADC) within at least one of the first band circuit and the second band circuit.

16. A dynamic data rate adjusting method of a communication device, wherein the communication device comprises a first transceiver path circuit for transmitting or receiving signals in a first band a first band and a second transceiver path circuit for transmitting or receiving signals in a second band, and further comprises a controller coupled to the first transceiver path circuit and the second transceiver path circuit, and the method comprising:
the controller detecting the communication status between the communication device and a first linked device and a second linked device;
when detecting that the communication device communicates with the first linked device on a first channel through the first transceiver path circuit and the communication device communicates with or intends to communicate with the second linked device on a second channel, the controller further executing a first determination to determine whether one or more channel interference effects exist between a first signal transmitted on the first channel and a second signal transmitted on the second channel, and generating an interference determination result;
the controller further executing a second determination to determine whether the communication between the communication device and the second linked device on the second channel should be executed through the first transceiver path circuit or the second transceiver path circuit, and whether to adjust the data rate of at least one of the first channel and the second channel according to the interference determination result; and
the controller executing corresponding controls according to the result of the second determination.

17. The dynamic data rate adjusting method of claim 16, wherein the one or more channel interference effects comprise an aliasing effect between the first signal and the second signal.

18. The dynamic data rate adjusting method of claim 17, wherein:
when detecting that the communication device communicates with the first linked device on the first channel through the first transceiver path circuit and the communication device communicates with the second linked device on a second channel through any of the first transceiver path circuit and the second transceiver path circuit, and the interference determination result indicates that the aliasing effect does not exist, the result of the second determination is not to adjust the data rate of both of the first channel and the second channel and not to adjust the communication between the communication device and the second linked device, the controller keeping the data rate of both of the first channel and the second channel and keeps the communication between the communication device and the second linked device according to the result of the second determination; or
when detecting that the communication device communicates with the first linked device on the first channel through the first transceiver path circuit and the communication device intends to communicates with the second linked device on a second channel, and the interference determination result indicates that the aliasing effect does not exist, the result of the second determination is not to adjust the data rate of both of the first channel and the second channel and the communication between the communication device and the second linked device on the second channel should be executed through the first or second transceiver path circuit, the controller keeping the data rate of both of the first channel and the second channel and controls the communication between the communication device and the second linked device on the second channel to be executed through the first or second transceiver path circuit according to the result of the second determination.

19. The dynamic data rate adjusting method of claim 17, wherein the one or more channel interference effects further comprise a channel spacing effect between the first signal and the second signal;
wherein when detecting that the communication device communicates with the first linked device on the first channel through the first transceiver path circuit and the communication device communicates with the second linked device on the second channel through the first transceiver path circuit, and the interference determination result indicates that the aliasing effect is detected and the channel spacing effect is not detected, the result of the second determination is to increase the data rate of at least one of the first channel and the second channel and the communication between the communication device and the second linked device on the second channel should be executed through the second transceiver path circuit, the controller increasing the corresponding data rate and controls the communication between the communication device and the second linked device on the second channel to be executed through the second transceiver path circuit according to the result of the second determination; or
wherein when detecting that the communication device communicates with the first linked device on the first channel through the first transceiver path circuit and the communication device intends to communicates with the second linked device on a second channel, and the interference determination result indicates that the aliasing effect is detected and the channel spacing effect is not detected, the result of the second determination is to increase the data rate of at least one of the first channel and the second channel and the communication between the communication device and the second linked device on the second channel should be executed through the second transceiver path circuit, the controller increasing the corresponding data rate and controls the communication between the communication device and the second linked device on the second channel to be executed through the second transceiver path circuit according to the result of the second determination.

20. The dynamic data rate adjusting method of claim 19, wherein when the communication device communicates with the first linked device on the first channel through the first transceiver path circuit and the communication device communicates with the second linked device on the second channel through the first transceiver path circuit, the first channel and the second channel use the first transceiver path circuit in a Multi-Channel Concurrent (MCC) mode; and
when the communication device communicates with the first linked device on the first channel through the first transceiver path circuit and the communication device communicates with the second linked device on the second channel through the second transceiver path circuit, the first channel and the second channel use the first transceiver path circuit and the second transceiver path in a Dual band Dual Concurrent (DBDC) mode.
